(19) United States
(12) Patent Application Publication
(10) Pub. No.: US 2026/0008144 A1
(43) Pub. Date: Jan. 8, 2026

(54) TOOL EXCHANGE SYSTEM OF MACHINE TOOL

(71) Applicant: CHEN SOUND INDUSTRIAL CO.,LTD., TAICHUNG CITY (TW)

(72) Inventor: HO-HSUN TSAI, TAICHUNG CITY (TW)

(21) Appl. No.: 19/259,501

(22) Filed: Jul. 3, 2025

(30) Foreign Application Priority Data
Jul. 5, 2024 (TW) 113125308

(51) Int. Cl. B23Q 3/155

(52) U.S. Cl. CPC B23Q 3/15526; B23Q 3/1554

(57) ABSTRACT

A tool magazine system, disposed on a machine tool having a work platform and a spindle, includes a tool storage device and a tool changing device. The tool storage device is disposed on a front side of the spindle and has a plurality of tool carrying units arranged in parallel along a Y-axis. Each tool carrying unit has a lifting frame and a tool clamping seat positioned on the lifting frame. The lifting frame ascends and descends along the Z-axis and is switchable between a tool storage position and a tool change standby position. The tool changing device detaches and reattaches the tool clamping seat with respect to the lifting frame, driving the tool clamping seat to move along the Y-axis to a tool change position, such that the spindle takes or returns the tool holder from or to the tool clamping seat.

### BACKGROUND OF THE DISCLOSURE

### 1. Field of the Disclosure

The present disclosure relates to machine tools, and more particularly, to a tool magazine system of machine tool.

### 2. Description of the Related Art

To improve the machining efficiency, machine tools are usually provided with a tool changing arm and a tool magazine, whereby the tool changing arm exchanges the tool holder on the spindle with the tool holder in the tool magazine. However, such a tool magazine features a bulky structure that occupies significant space, and is structurally complex and not applicable to multi-spindle machine tools.

Also, the tool magazine of a multi-spindle machine tool is typically installed on the rear or lateral side of the machine tool, resulting in a long tool changing travel and extended tool changing time, and the number of tool holders that can be stored in the tool magazine is limited.

CN105873720A disclosed a tool magazine independently disposed on the lateral side of the work platform, so as to divide the frame area and the automatic tool changer (ATC) area. However, such a tool magazine occupies a large space and has a complex structure.

Accordingly, to improve the above-mentioned technical issues, the present disclosure provides a tool magazine system of machine tool capable of changing tool holders in batches according to the number of spindles of the machine tool.

### SUMMARY OF THE DISCLOSURE

The present disclosure aims at resolving the issues of low tool changing efficiency and large space occupation of the conventional tool magazine in machine tools by providing a tool magazine system of machine tool to simplify the required actions for tool exchange, reduce the tool changing time, and enhance the tool changing efficiency.

For achieving the aforementioned objectives, the present disclosure provides a tool magazine system disposed on a machine tool having a work platform and a plurality of spindles, the tool magazine system comprising:
a tool storage device disposed on a front side of the spindle and having a plurality of tool carrying units arranged in parallel along a Y-axis, each of the tool carrying unit having a lifting frame and a tool clamping seat positioned on the lifting frame, the lifting frame being configured to ascend and descend along a Z-axis, so as to be switchable between a tool storage position and a tool change standby position; and
a tool changing device configured to detach and reattach the tool clamping seat with respect to the lifting frame at the tool change standby position, so as to drive the tool clamping seat to move along the Y-axis to a tool change position, such that the spindle takes or returns the tool holder from or to the tool clamping seat.

With such configuration, before moving to the tool change position, the tool clamping seat which stores the tool holder moves only along the Z-axis and Y-axis, so as to simplify the motions needed for changing the tool clamping seat, reducing the replacement time of the tool clamping seat and improving tool changing efficiency.

Also, the tool storage device is arranged on the front side of the spindle and above the work platform, thereby reducing the space of the machine tool occupied by the tool storage device.

The plurality of tool carrying units of the tool storage device are capable of simultaneously storing multiple sets of tool holders, thereby facilitating applications where multiple tools are needed for machining.

The aforementioned contents and other objectives, technical features and advantages of the present disclosure will be best understood referring to following detailed description, embodiments, and attached drawings.

### BRIEF DESCRIPTION OF THE DRAWINGS

FIG. 1 is a perspective view of the tool magazine system applied to a machine tool in accordance with an embodiment of the present disclosure.

FIG. 2 is a side view of the tool magazine system applied to a machine tool in accordance with an embodiment of the present disclosure.

FIG. 3 is a structural schematic view illustrating the tool storage device in accordance with an embodiment of the present disclosure.

FIG. 4 is a structural schematic view of a Z-axis lifting unit in accordance with an embodiment of the present disclosure, illustrating the combination state of the position limiting rod and the position limiting hole.

FIG. 5 is a schematic view illustrating the relative position between the tool carrying unit and the tool changing device, showing the positioning block being positioned on the side bar by the positioning member.

FIG. 6 is a schematic view illustrating the downward movement of the tool clamping seat, showing the tool clamping seat at the tool change standby position.

FIG. 7 is a schematic view illustrating the pushing member driving the tool clamping seat to move toward the spindle, with the lifting frame ascending to its original position.

FIG. 8 is a schematic view illustrating the upward return movement of the lifting frame, with the tool clamping seat moving to the tool change position.

FIG. 9 is a schematic view illustrating the tool clamping seat moving to the tool change position, allowing the spindle to take the tool holder.

FIG. 10 is a schematic view illustrating the return motion of the tool clamping seat moving away from the spindle along the Y-axis.

FIG. 11 is a side view of the tool magazine system in accordance with another embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

Embodiments of the present disclosure are illustrated in detail along with the drawings. However, the technical features included by the present disclosure are not limited to certain embodiments hereby provided. Scope of the present disclosure shall be referred to the claims, which include all the possible replacements, modifications, and equivalent features. Also, to enhance readability, parts of the components are omitted in certain illustrations, or depicted using imaginary lines.

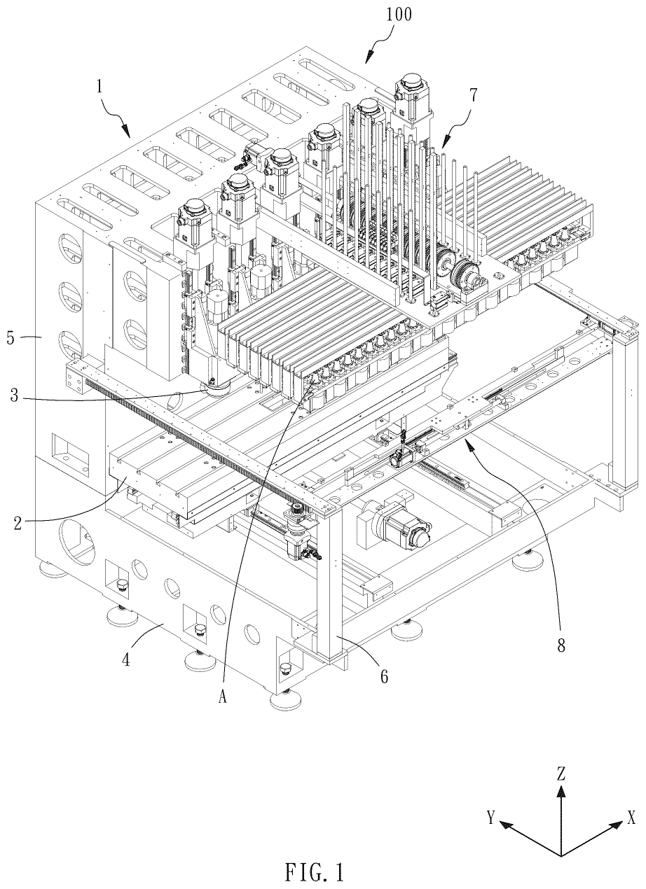

Referring to FIG. 1 to FIG. 10, the present disclosure provides a tool magazine system 100 disposed on a machine tool 1 having a work platform 2 and a spindle 3. Therein, the machine tool 1 is allowed to be a single-spindle or a multi-spindle machine tool. When the machine tool 1 is a multi-spindle machine tool, a plurality of spindles 3 are included. The work platform 2 is disposed on a base 4 of the machine tool 1, with a column 5 disposed on the base 4. The spindle 3 is disposed on the column 5 and movable along the Z-axis. A frame body 6 is disposed on one side of the machine tool 1 in opposite to the column 5. The tool magazine system 100 comprises a tool storage device 7 and a tool exchanging device 8.

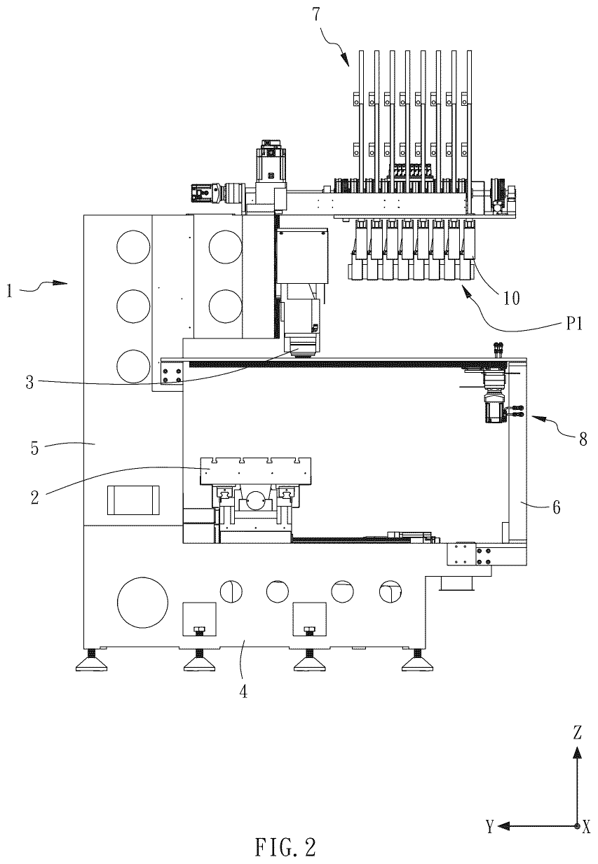

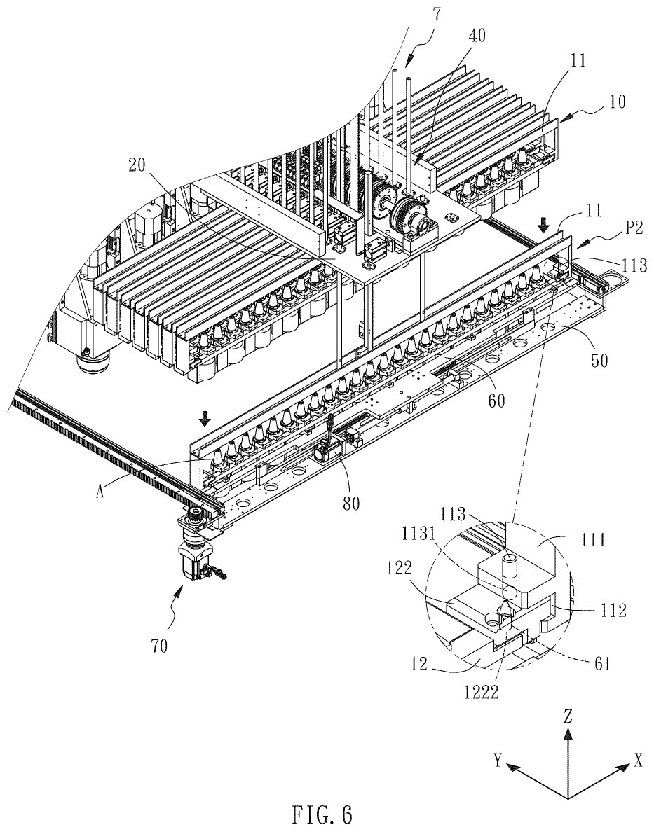

The tool storage device 7 is arranged on the front side of the spindle 3 and above the base 4 and the work platform 2. The tool storage device 7 comprises a plurality of tool carrying units 10 disposed in parallel along the Y-axis. Each tool carrying unit 10 has a lifting frame 11 and a tool clamping seat 12 positioned on the lifting frame 11. The lifting frame 11 is allowed to ascend and descend along the Z-axis, so as to be switchable between a tool storage position P1 (as shown in FIG. 2) and a tool change standby position P2 (as shown in FIG. 6). The tool clamping seat 12 comprises a plurality of tool clamping portions 121 storing a plurality of tool holders A, as shown in FIG. 1 to FIG. 5.

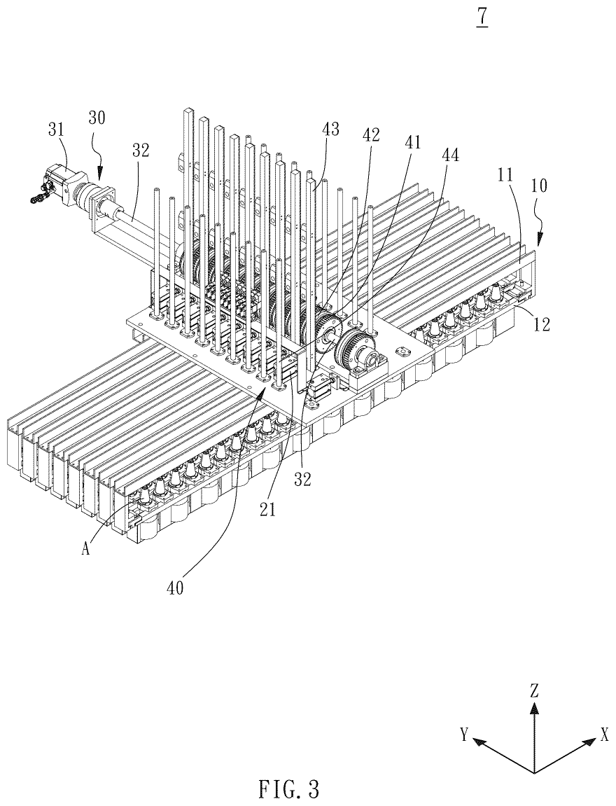

Referring to FIG. 1 and FIG. 3, in the embodiment, the tool storage device 7 further comprises a fixing seat 20, a driving unit 30, and a plurality of Z-axis lifting units 40. The fixing seat 20 is disposed on the top of the column 5 of the machine tool 1 and extends toward the front side of the machine tool 1. The driving unit 30 comprises a drive source 31 and a driving shaft 32 that are connected, wherein the drive source 31 is a motor, and the driving shaft 32 is connected to the motor and mounted on the fixing seat 20. The plurality of Z-axis lifting units 40 are disposed at the tool storage position P1 and respectively connected with the driving shaft 32 and each lifting frame 11; in other words, the Z-axis lifting unit 40 and the driving shaft 32 are disposed on the fixing seat 20.

Each Z-axis lifting unit 40 comprises a driving gear 41, a clutch member 42, and a rack 43. The driving gear 41 and the clutch member 42 are coaxially connected with the driving shaft 32. The driving gear 41 is engaged with the rack 43. The rack 43 passes through the fixing seat 20 and is connected to the lifting frame 11. The clutch member 42 is controlled to be clutched with and declutched from the driving gear 41. When the clutch member 42 is declutched from the driving gear 41, the driving gear 41 is not driven by the driving shaft 32; when the clutch member 42 is clutched with the driving gear 41, the driving gear 41 is allowed to be driven by the driving shaft 32. Therefore, when the clutch member 42 is clutched with the driving gear 41 and driven by the driving shaft 32, the driving gear 41 drives the rack 43 to move along the Z-axis, whereby the lifting frame 11 and the tool clamping seat 12 move to the tool change standby position P2 as shown in FIG. 6.

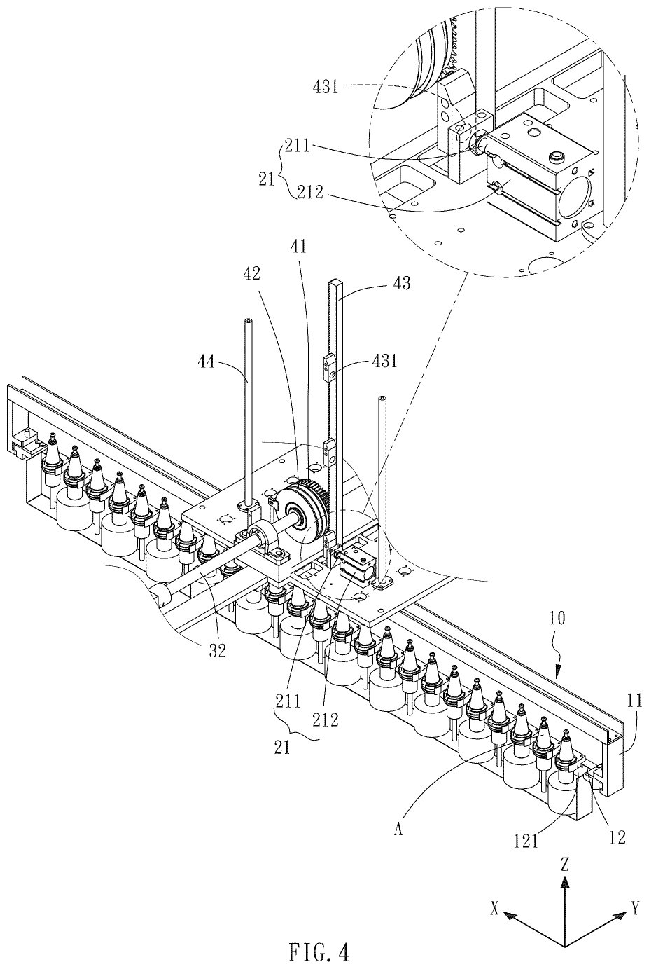

Referring to FIG. 3 and FIG. 4, in view of FIG. 2 and FIG. 6, the fixing seat 20 comprises a position limiting unit 21 disposed on one side of each Z-axis lifting unit 40, so as to selectively limit the height of the rack 43, such that the lifting frame 11 is maintained at the tool storage position P1 or the tool change standby position P2. Therein, the position limiting unit 21 has a position limiting rod 211 and a pressure cylinder 212 driving the motion of the position limiting rod 211. The rack 43 has a plurality of position limiting holes 431 disposed on one side in longitudinal arrangement, wherein three position limiting holes 431 are included and configured to receive the position limiting rod 211 inserted therethrough, so as to limit the height position of the rack 43. For example, when the position limiting rod 211 is inserted into the uppermost position limiting hole 431, the lifting frame 11 is arranged at the tool change standby position P2. When the position limiting rod 211 is inserted into the lowermost position limiting hole 431, the lifting frame 11 is arranged at the tool storage position P1. When the position limiting rod 211 is inserted into the middle position limiting hole 431, the lifting frame 11 is arranged at a maintenance position for inspection and repair purposes.

Also, the Z-axis lifting unit 40 has a guide rod 44 disposed on two sides of the driving gear 41 and slidably passing through the fixing seat 20 to be connected with the lifting frame 11, so as to maintain the stability of the lifting frame 11 during ascending and descending movement.

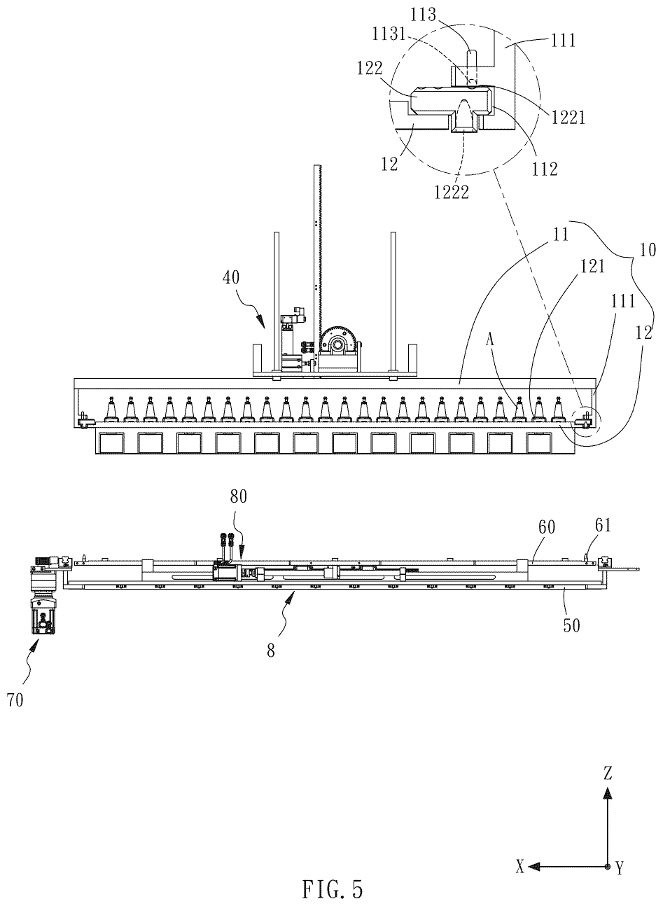

Referring to FIG. 5, the lifting frame 11 has a side bar 111 disposed on two sides thereof, and each side bar 111 has a transverse groove 112. The tool clamping seat 12 and each of the side bars 111 are provided with a corresponding positioning block 122, and a portion of each positioning block 122 is configured to be slidably engaged with the transverse groove 112 of the side bar 111 along the Y-axis. In the embodiment, a positioning member 113 is disposed between the positioning block 122 and the side bar 111, wherein the positioning member 113 is movable with respect to the Z-axis, so as to generate a positioning relationship between the positioning block 122 and the side bar 111. The positioning member 113 is disposed on the side bar 111, and an end portion of the positioning member 113 has an elastically retractable bead 1131, which is configured to selectively protrude toward the transverse groove 112. A recess 1221 corresponding to the bead 1131 is formed on the top portion of the positioning block 122. When the positioning block 122 is received in the transverse groove 112, the bead 1131 protrudes into the transverse groove 112 to be positioned in the recess 1221, thereby forming a positioning state between the positioning block 122 and the side bar 111. Also, a connection hole 1222 is formed on the bottom portion of the positioning block 122.

The tool changing device 8 is configured to detach and reattach the tool clamping seat 12 with respect to the lifting frame 11 at the tool change standby position P2, so as to drive the tool clamping seat 12 to move along the Y-axis to a tool change position P3, such that the spindle 3 takes or returns the tool holder A from or to the tool clamping seat 12.

Referring to FIG. 5 and FIG. 6, the tool changing device 8 comprises a sliding seat 50, a pushing member 60, a Y-axis driving unit 70, and an X-axis driving unit 80. The pushing member 60 is disposed on the sliding seat 50. The Y-axis driving unit 70 is disposed between the column 5 and the frame body 6 and configured to drive the sliding seat 50 to move along the Y-axis. The X-axis driving unit 80 is disposed between the sliding seat 50 and the pushing member 60 and configured to drive the pushing member 60 to move with respect to the sliding seat 50 along the X-axis. The pushing member 60 has a connection post 61 disposed on two sides corresponding to the positioning blocks 122 of the tool clamping seat 12, so that when the lifting frame 11 moves to the tool change standby position P2, the connection hole 1222 are engaged with the connection post 61 to achieve a positioning effect. Therein, the Y-axis driving unit 70 comprises components such as a slide rail, a slider, a motor, and a rack. The rack is disposed between the frame body 6 and the column 5. The motor is engaged with the rack through a gear. Through the cooperation of the slide rail and the slider, the slide seat 50 is driven by the motor to move along the Y-axis. The X-axis driving unit 80 comprises components such as a slide rail, a slider, an electric motor, and a threaded rod. The slide rail and the slider of the X-axis driving unit 80 are disposed between the pushing member 60 and the sliding seat 50, such that the pushing member 60 is able to move with respect to the slide seat 50 along the X-axis through the operation of the threaded rod driven by the electric motor.

The description above refers to the case where the spindle 3 moves only along the Z-axis. If the spindle 3 is configured to move along both the X-axis and the Z-axis, the X-axis driving unit 80 is not required.

Referring to FIG. 6 to FIG. 10, the steps and process for executing the tool mounting operation of the present disclosure are illustrated. Referring to FIG. 6, one of the tool carrying units 10 is driven by the corresponding Z-axis lifting unit 40, whereby the lifting frame 11 drives the tool clamping seat 12 to descend along the Z-axis to the tool change standby position P2. Meanwhile, the pushing member 60 is driven by the sliding seat 50 to move beneath the lifting frame 11, so as to align the connection post 61 with the connection hole 1222. When the tool clamping seat 12 descends along the Z-axis to the tool change standby position P2, the connection hole 1222 and the connection post 61 are engaged and positioned with each other, thereby securing the tool clamping seat 12 onto the pushing member 60.

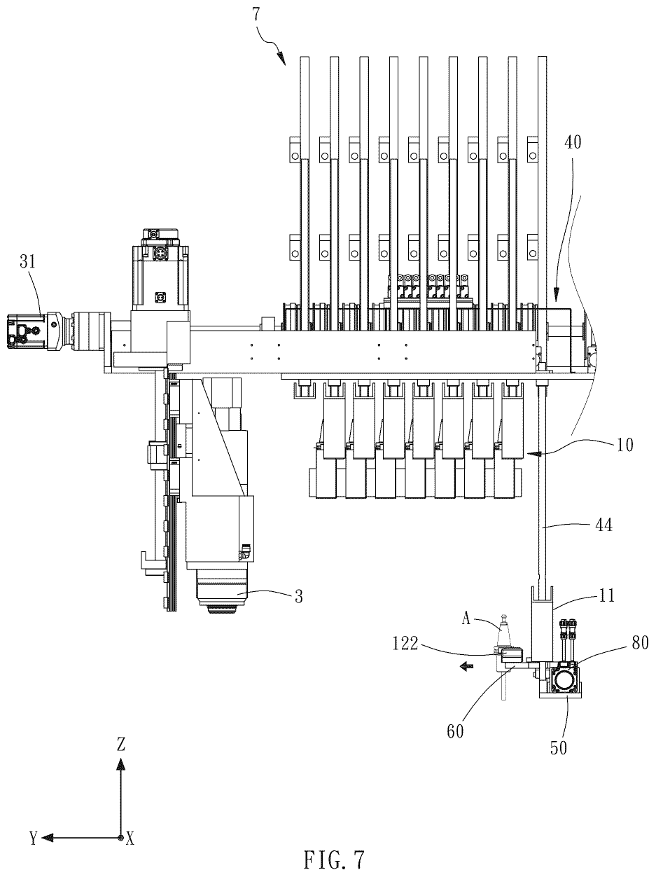

Referring to FIG. 7 in view of FIG. 5, when the sliding seat 50 moves along the Y-axis toward the spindle 3, the pushing member 60 drives the tool clamping seat 12 to move toward the spindle 3, and the bead 1131 is elastically compressed to retract to be disengaged from the recess 1221, causing the lifting frame 11 of the tool carrying unit 10 to separate from the positioning block 122 of the tool clamping seat 12.

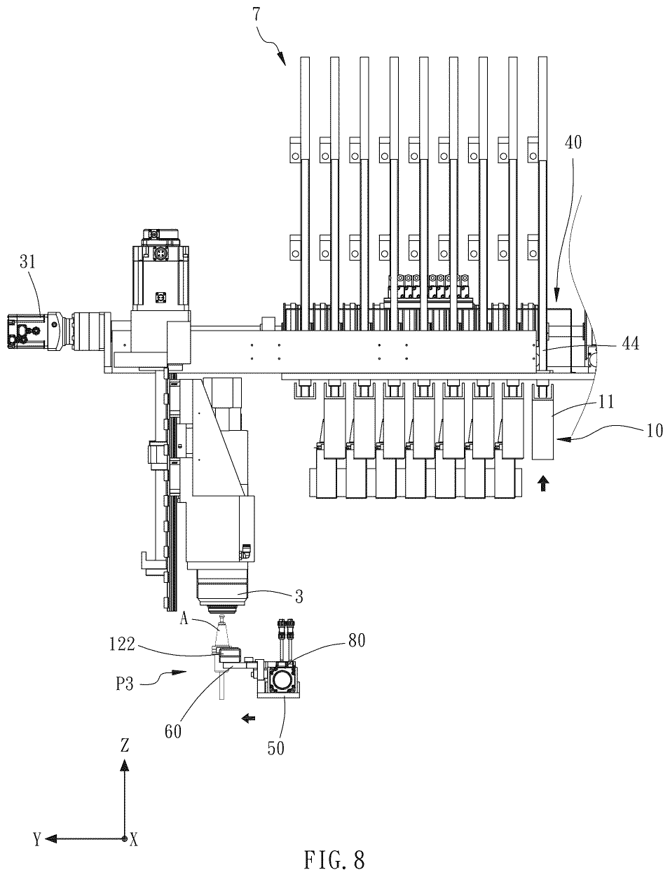

Referring to FIG. 8 in following FIG. 7, when the lifting frame 11 separates from the positioning block 122, the lifting frame 11 ascends back to the original position along the Z-axis, and the tool clamping seat 12 moves toward the spindle 3 to the tool change position P3 beneath the spindle 3.

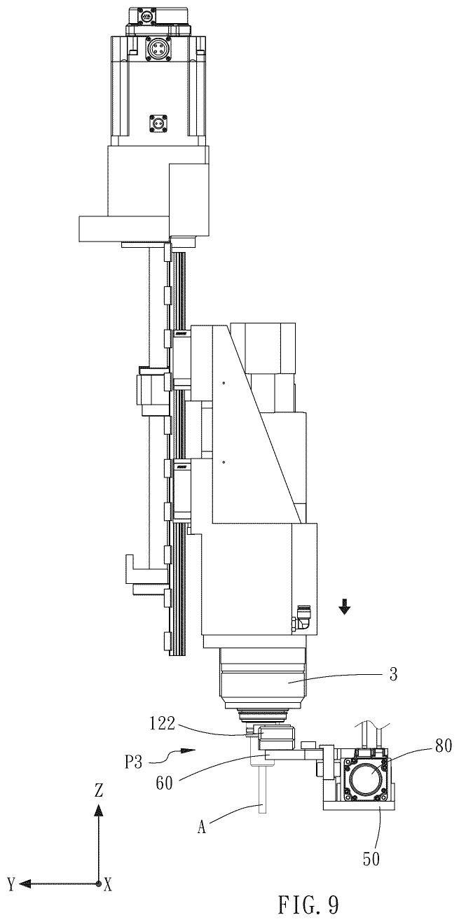

Referring to FIG. 9, the spindle 3 moves downward along the Z-axis to align the spindle hole with the tool holder A on the corresponding tool clamping seat 12 and complete the tool gripping operation. Then, the spindle 3 moves upward to its original position to remove the tool holder A from the tool clamping seat 12, followed by performing the subsequent machining operation.

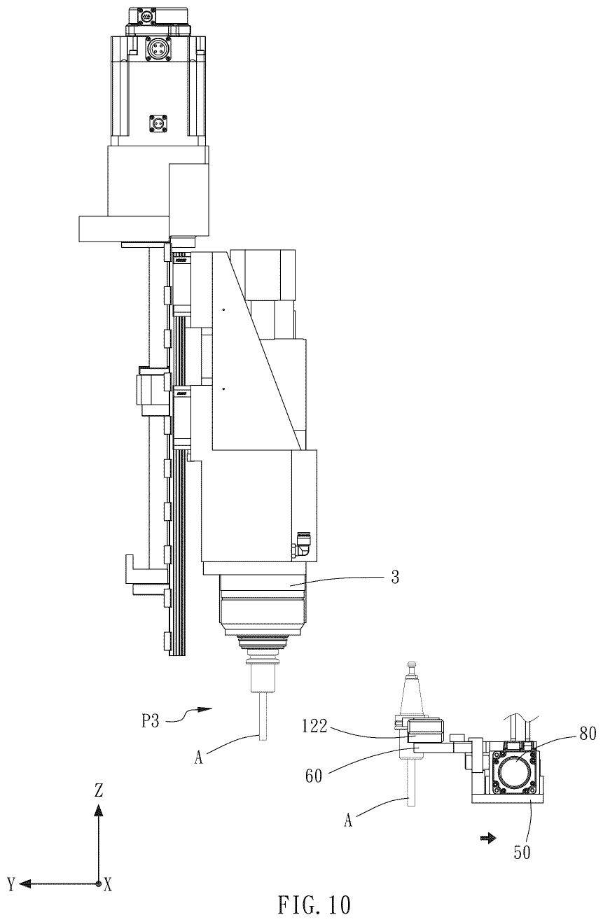

Referring to FIG. 10, after completing the aforementioned tool mounting operation, the sliding seat 50 drives the tool clamping seat 12 to return to the tool change standby position P2 shown in FIG. 6, awaiting the next tool change request. Accordingly, when the tool holder A on the spindle 3 is to be replaced again, the tool clamping seat 12 moves as described above and position an empty tool clamping portion 121 (without a tool holder A mounted thereon) at the tool change position P3, allowing the spindle 3 to place the old tool holder A onto the clamping portion 121. Together with the aforementioned movement of the pushing member 60 along the X-axis and the vertical movement of the spindle 3 along the Z-axis, the spindle 3 engages and takes another tool holder A from the tool clamping seat 12, thereby completing the tool changing operation. When all tool holders A on the tool clamping seat 12 have been used and replaced, the above operations are performed in-reverse to allow the tool carrying unit 10 to send the tool clamping seat 12 back to the storage position P1 shown in FIG. 2, and replace it with the tool clamping seat 12 of another tool carrying unit 10. Through the structural principles above, the present disclosure achieves the purpose of tool mounting and tool changing.

Notably, in some embodiments, the machine tool 1 is a gantry type machine tool, and the column 5 thereof has a through space allowing the tool storage device 7 to be disposed behind the column 5, so that tool changing operation is performed by moving the tool storage device 7 from the rear to the front.

In some embodiments, when a small number of tool clamping seats 12 is provided, the Z-axis lifting unit 40 is allowed to be replaced by a cylinder to control the vertical movement.

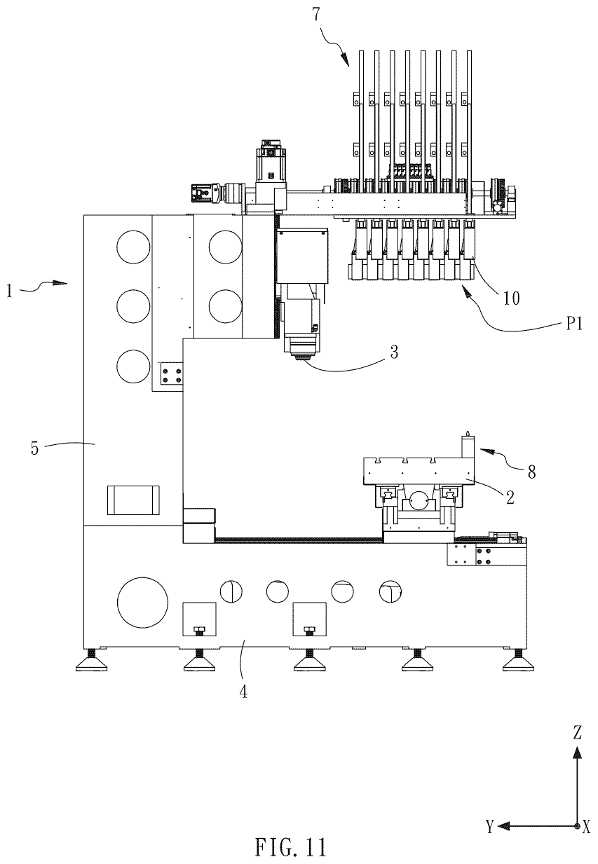

Referring to FIG. 11, another embodiment of the present disclosure is illustrated. The difference from the previous embodiment lies in that the tool changing device 8 is disposed on one side of the work platform 2, which is capable of moving along the X-axis and Y-axis. Such structural configuration eliminate the need of components such as the previously mentioned Y-axis driving unit 70 and X-axis driving unit 80.

In other embodiments, in addition to positioning the positioning block 122 of the tool clamping seat 12 and the side bar 111 by use of the elastically retractable bead 1131 of the positioning member 113, a permanent magnet or electromagnet is also usable to magnetically attach and secure the positioning block 122 and side bar 111 so as to replace the positioning member 113. The present disclosure is not only applicable to vertical machine tools as described above, but also applicable to horizontal machine tools. In such cases, by simply adjusting the tool storage and the tool holder orientation of the tool clamping seat 12 to the horizontal direction to match the horizontal spindle direction of the machine tool, the horizontally moving spindle is able to cooperate with the present disclosure, so as to smoothly perform the tool changing operation.

With the foregoing configuration, advantages of the present disclosure will be illustrated below.

During the tool changing operation of the present disclosure, the tool clamping seat 12 moves from the tool storage position P1 to the tool change standby position P2, and is subsequently driven to move downward to the tool change position P3 by the sliding seat 50 of the tool changing device 8, so as to perform the tool changing operation. Therefore, before reaching the tool change position P3, the tool clamping seat 12 moves only along the Z-axis and Y-axis directions, thereby simplifying the motions required for replacing the tool clamping seat 12 and significantly reducing the replacement time of the tool clamping seat 12, so as to improve the tool changing and machining efficiency.

The tool storage device 7 of the present disclosure is disposed on the front side of the spindle 3 and above the work platform 2, thereby reducing the space of the machine tool occupied by it.

The plurality of tool carrying units 10 of the tool storage device 7 are capable of simultaneously storing multiple sets of tool holders A for facilitating applications where multiple tools are needed for machining, and expanding the applicability of tool changing operations to meet diverse machining demands.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A tool magazine system disposed on a machine tool having a work platform and a spindle, the tool magazine system comprising:
a tool storage device disposed on a front side of the spindle and having a plurality of tool carrying units arranged in parallel along a Y-axis, each of the tool carrying unit having a lifting frame and a tool clamping seat positioned on the lifting frame, the lifting frame being configured to ascend and descend along a Z-axis, so as to be switchable between a tool storage position and a tool change standby position; and
a tool changing device configured to detach and reattach the tool clamping seat with respect to the lifting frame at the tool change standby position, so as to drive the tool clamping seat to move along the Y-axis to a tool change position, such that the spindle takes or returns the tool holder from or to the tool clamping seat.

2. The tool magazine system of claim 1, wherein the tool storage device is arranged above the work platform and comprises a driving unit; the driving unit comprises a drive source and a driving shaft connected to the drive source; a plurality of Z-axis lifting units are disposed at the tool storage position; the plurality of Z-axis lifting units are connected to the driving shaft and the lifting frame, respectively.

3. The tool magazine system of claim 2, wherein each of the Z-axis lifting units comprises a driving gear, a clutch member, and a rack; the driving gear and the clutch member are coaxially connected with the driving shaft; the driving gear is engaged with the rack, and the rack is connected to the lifting frame; the clutch member is configured to be clutched with and declutched from the driving gear; when the clutch member is clutched with the driving gear and driven by the driving shaft, the driving gear drives the rack to move along the Z-axis, such that the lifting frame move to the tool change standby position.

4. The tool magazine system of claim 3, wherein the tool storage device comprises a fixing seat disposed on the machine tool; the Z-axis lifting units and the driving shaft are disposed on the fixing seat; the rack passes through the fixing seat; the fixing seat comprises a position limiting unit disposed on one side of each of the Z-axis lifting units, so as to selectively limit a height of the rack, such that the lifting frame is maintained at the tool storage position or the tool change standby position.

5. The tool magazine system of claim 4, wherein the position limiting unit has a position limiting rod and a pressure cylinder driving a motion of the position limiting rod; the rack has a plurality of position limiting holes disposed on one side thereof, which are configured to receive the position limiting rod inserted therethrough, so as to limit the height of the rack; the Z-axis lifting unit has a guide rod disposed on two sides of the driving gear and slidably passing through the fixing seat to be connected with the lifting frame.

6. The tool magazine system of claim 2, wherein the lifting frame has a side bar disposed on two sides thereof, respectively; the tool clamping seat and each of the side bars are provided with a positioning block, and a portion of each positioning block is configured to be slidable with respect to the side bar along the Y-axis; a positioning member is disposed between the positioning block and the side bar, and the positioning member is movable with respect to the Z-axis, so as to generate a positioning relationship between the positioning block and the side bar.

7. The tool magazine system of claim 6, wherein the side bar has a transverse groove, and a portion of the positioning block is configured to be slidably engaged with the transverse groove; the positioning block has a connection hole formed on a bottom portion thereof; the tool changing device comprises a sliding seat and a pushing member; the sliding seat is movable along the Y axis; the pushing member is disposed on the sliding seat and movable with respect to the sliding seat along the X-axis; the pushing member has a connection post disposed on two sides thereof corresponding to the positioning blocks; when the lifting frame moves to the tool change standby position, the connection hole are engaged and positioned with the connection post.

8. The tool magazine system of claim 7, wherein the machine tool comprises a base, on which the work platform is disposed, with a column disposed on the base; the spindle is disposed on the column and movable along the Z-axis; a frame body is disposed on one side of the machine tool in opposite to the column; the tool changing device comprises a Y-axis driving unit and an X-axis driving unit; the Y-axis driving unit is disposed between the column and the frame body, and configured to drive the sliding seat to move along the Y-axis; the X-axis driving unit is disposed between the sliding seat and the pushing member, and configured to drive the pushing member to move along the X-axis.

9. The tool magazine system of claim 1, wherein the tool changing device is disposed on one side of the work platform; the work platform is movable along the X-axis and the Y-axis.
